(19) United States
(12) Patent Application Publication
(10) Pub. No.: US 2008/0034197 A1
(43) Pub. Date: Feb. 7, 2008

(54) Method of encrypting or decrypting data packets of a data stream as well as a signal sequence and data processing system for performing the method

(75) Inventors: Christian Engel, Stahnsdorf (DE); Thomas Berndes, Stahnsdorf (DE); Andreas Gehring, Berlin (DE)

Correspondence Address: DAVIDSON BERQUIST JACKSON & GOWDEY LLP, 4300 WILSON BLVD., 7TH FLOOR, ARLINGTON, VA, 22203, US

(73) Assignee: ENGEL Technologieberatung, Entwicklung/Verkauf von Soft- und Hardware KG, Stahnsdorf (DE)

(21) Appl. No.: 11/583,108

(22) Filed: Oct. 19, 2006

(30) Foreign Application Priority Data
Oct. 21, 2005 (DE) DE 102005051577.0

(51) Int. Cl. H04L 9/00

(52) U.S. Cl. 713/150

(57) ABSTRACT

This invention relates to a method of encrypting data packets of a data stream and decrypting plurally encrypted data of a data stream that provides an increased level of data security and can be automated using a signal sequence (a computer program product) or a data processing device. A data packet to be encrypted or a data packet to be decrypted is automatically encrypted or decrypted sequentially in at least two subsequent processing steps using different coding algorithms and different assigned coding keys. For encryption, a number, type, and sequence of different coding algorithms is first determined (S10) that is to be used in the subsequent encryption operations and respective different coding keys are assigned to the coding algorithms (S12, S13). Then the data packet to be encrypted is encrypted sequentially in at least two subsequent encryption operations (S16, S17) to obtain a plurally encrypted data packet. For decryption, an unencrypted coding characteristic assigned to the plurally encrypted data packet and specifying at least one coding algorithm and an assigned coding key is detected automatically. The coding characteristic thus allows sequential decryption in at least two subsequent decryption operations.

### CROSS-REFERENCE TO RELATED APPLICATIONS

The present application claims priority to German Application No. 10 2005 051 577.0 filed Oct. 21, 2005, the entire contents of which are herein incorporated by reference.

### DESCRIPTION

This invention relates to a method of encrypting or decrypting data packets of a data stream as well as a signal sequence and a data processing system for performing the method.

Increasing globalization of the economy entails that various locations of an enterprise as well as locations of vendors and customers are frequently spread all over the world. Various types of transmission networks such as telephone networks, radio networks and computer networks (such as the World Wide Web/Internet) are used to facilitate data exchange among these parties. This applies similarly to the data exchange among individuals or public institutions.

It is a drawback of the transmission networks mentioned above that a skilled third party can intercept, tap into, or manipulate this data in a comparatively simple way. This is problematic because sensitive data that may, for example, contain a business secret are exchanged via the network.

It is known that this problem can be solved if the sender encrypts the data to be exchanged using a coding key and a coding algorithm prior to transmitting it via the network. The encrypted data is transmitted via the transmission network and decrypted by a respective recipient using the same coding key and coding algorithm to retrieve the original data. The coding key and the coding algorithm are selected so that the encrypted data is difficult to decrypt by an unauthorized third party who does not know the coding key and/or coding algorithm. To ensure a certain level of security, the coding key and/or coding algorithm may therefore be known only to the sender and the authorized recipient.

The respective security level depends among other factors on the type of coding algorithm used and on the length of the coding key used. The coding key and coding algorithm are defined as a key or algorithm agreed individually between the sender and recipient and not depending on a network protocol, operating system, or the like of the transmission network used. Such dependency exists, for example, for the combination of an SSL connection and a VPN connection. The type of algorithm used for SSL and VPN connections is provided independently in their respective configuration files so that the same algorithm may be used by both of them.

The problem of transferring encrypted data as described above is that encrypting and decrypting the data using a coding key and a coding algorithm requires some expertise and may be very time-consuming. As a result, encryption is frequently not used, even when exchanging sensitive data.

The past has also shown that, with the ever increasing capacity of today's computers, unauthorized parties succeed faster in decrypting data encrypted with a coding key and a coding algorithm even without knowing the coding key and/or coding algorithm used. This problem is sharpened by “grid computing” where the computing power required to overcome a coding algorithm or coding key is provided by a multitude of computers distributed across a network.

It is known from WO 8701483 that the problem can be solved by encrypting data to be encrypted multiple times using the same coding algorithm and different coding keys.

This approach has the disadvantage, however, that security is dramatically reduced despite multiple encryption if an unauthorized party managed to obtain knowledge about the coding algorithm and how to overcome it. It is then relatively simple to determine the various coding keys.

Another solution to the problem known from WO 0026791 involves dividing the data to be encrypted into partial data and use different coding algorithms to encrypt this partial data.

The advantage is that the security of the partial data is reduced only if an unauthorized third party has obtained knowledge about one of the coding algorithms used and how to overcome it. Still, it is relatively easy for an unauthorized third party to get hold of this partial data. This may be highly detrimental if the data is sensitive.

Because of the problems mentioned above, automatic encryption of data to be transferred by some hardware is difficult to achieve as hardware becomes obsolete fast and will then have to be replaced.

It is therefore the object of this invention to provide a method of encrypting or decrypting data packets of a data stream that is difficult to break by unauthorized third parties even with increased computer power and thus comprises a particularly high level of security.

It is another object of this invention to provide a signal sequence and a data processing system for executing (performing) the method thereof that are characterized by a particularly simple, cost-efficient, and reliable structure.

The object described above is achieved by a method of encrypting data packets of a data stream having the characteristics of independent claim 1.

The object described above is further achieved by a method of decrypting plurally encrypted data packets of a data stream having the characteristics of independent claim 7.

The object described above is further achieved by a signal sequence, preferably in the form of a computer program product that causes the method to be executed according to any one of claims 1 through 10 if loaded into a data processor (especially a microprocessor) of a data processing system.

And finally, the object described above is achieved by a data processing system in that the data processing system receives at least data packets of one data stream, processes the data packets received in accordance with a predefined instruction, and is programmed and set up to execute the method according to any one of claims 1 through 10.

Advantageous improvements can be found in the respective dependent claims.

According to this invention, a method of encrypting data packets of a data stream by which a data packet to be encrypted is automatically encrypted sequentially in at least two subsequent encryption operations (encryption stages) comprises the following steps: determining the number, type, and sequence of different coding algorithms to be used in the subsequent encryption operations. Determining the different coding keys to be used in the subsequent encryption operations. Assigning a coding key to one respective coding algorithm in one respective encryption operation and sequentially encrypting a data packet to be encrypted in at least two subsequent encryption operations to obtain a plurally encrypted data packet.

Thus the method according to the invention involves receiving data packets to be encrypted and running them sequentially through several encryption operations with different coding algorithms and coding keys and outputting them as plurally encrypted data packets.

The method according to the invention is in principle also suited for file encryption: Loaded files consist of a data stream of data packets. The size of a file is finite and variably depends on the content of the respective file. The file size is limited only by an underlying file system. Data packets however have a fixed maximum size that depends on the algorithms that process the data packets (such as an operating system). If the permissible size of a data packet is exceeded, it has to be segmented, i.e. distributed over at least two new data packets.

The data packets to be processed may be complete data packets comprising a protocol data part that can only be put down to the transmission protocol used and a user data part that contains the remaining data. Alternatively, the data packets to be processed may just be the user data parts separated from their protocol data parts.

A counter may be provided to ensure that the data is encrypted subsequently in at least two encryption operations, said counter being reset to zero at the start of the method and incremented after each encryption operation. This counter can also be used for finding out by comparison if the method ran through a defined number of different subsequent encryption operations.

It is pointed out that the sequence does not have to be determined again for each data packet but can once be defined permanently.

According to a preferred embodiment, the method further comprises the steps of creating an unencrypted coding characteristic for the plurally encrypted data packet and outputting the coding characteristic together with the plurally encrypted data packet. The coding characteristic at least specifies the coding algorithm used last and the associated coding key.

The output of the coding characteristic together with the plurally encrypted data packet causes an explicit or implicit assignment of the coding characteristic to the plurally encrypted data packet. An explicit assignment can be made by expressly naming the associated plurally encrypted data packet. An example of an implicit assignment is a correlation of the times at which the coding characteristic and the plurally encrypted data packet are output. It is important to point out that the coding characteristic contains neither the at least one coding algorithm nor the at least one coding key but only denotes them. It may for example indicate the name of the at least one coding algorithm used and the at least one assigned coding key. The steps of creating and outputting the coding characteristic may optionally be executed by a separate higher-order unit.

It may be preferred that the method comprises the step of adding the unencrypted coding characteristic created to the respective encrypted data packet in each encryption operation.

In this case, each coding characteristic preferably states only the coding algorithm and assigned coding key used in the respective current encryption operation. It should be pointed out that adding the coding characteristic to the respective encrypted data packet is optional only. Alternatively, the coding characteristic may be output together with the encrypted data packet after encryption in each encryption operation.

It may be preferable if each encryption operation of the method according to the invention includes the steps of determining at least one formatting instruction of the coding algorithm used in the respective encryption operation and of adjusting the structure of the data packet to be encrypted to the respective coding algorithm using the at least one formatting instruction. The at least one formatting instruction defines a structure of the data packets that can be encrypted using the respective coding algorithm.

Thus the formatting instruction is a rule depending on a respective coding algorithm for input data that can be processed by the respective algorithm. An example of such a formatting instruction is the block size of the data to be processed and so on.

Adjusting the data packet to be encrypted may preferably include the following: segmenting the data packet to be encrypted into multiple partial data packets to be encrypted. Using the partial data packets instead of the data packet to be encrypted. Creating an unencrypted segmenting characteristic for the partial data packets to be encrypted, said segmenting characteristic denoting partial data packets obtained by segmenting a single data packet and outputting the segmenting characteristic together with segmented partial data packets to be encrypted.

This may be required as the encrypted data packet may grow in size depending on the coding algorithm used in each encryption operation. Without planning for segmentation, there is a risk that the buffers provided in each encryption operation or a buffer provided centrally for data transfer may become too small for the encrypted data packets. As a result, the size of the data packet to be encrypted is automatically adjusted to the respective coding algorithm used in each encryption operation.

Alternatively, an expected maximum size of the plurally encrypted data packet can be estimated before running the first encryption operation or while running the first encryption operation. This can be done by multiplying expected enlargement factors depending on the respective coding algorithm in the respective encryption operations. As a result, the data packet to be encrypted can automatically be segmented at the outset based on the formatting instructions of the various coding algorithms so that maximum packet sizes of the data packets to be encrypted are not exceeded.

Alternatively, the segmenting characteristic may also be output jointly for all encryption operations at the end of the multiple encryption (plural encryption) of the data packet to be encrypted. Furthermore, the segmenting characteristic may optionally be added to the partial data packets to be encrypted in each encryption operation or at the end of the multiple encryption to the plurally encrypted data packet.

Furthermore, adjusting the data packet to be encrypted may include the creation of a data block containing the data packet to be encrypted and a block characteristic, said block characteristic identifying the data packet to be encrypted in the data block, and use of the data block instead of the data packet to be encrypted.

This procedure is also known as “padding” and produces data blocks based on a respective formatting instruction of a respective coding algorithm the size of which is a multiple of a block size of the respective coding algorithm. A data block to be encrypted can for example be filled at its end with characters (such as random data or predefined data) until the respective block size is reached. The number of inserted characters is noted down in the form of the block characteristic. The block characteristic may optionally be added, e.g., as the last character (byte) of the data block to the respective data block.

According to an embodiment, the method may further include splitting a main coding key into several different partial coding keys and assigning one partial coding key each to one respective coding algorithm in one respective encryption operation.

This is particularly useful in conjunction with the coding characteristic described above. In this case, a main coding key (consisting, for example, of a preset range of random numbers) may be permanently predefined. Ranges of the main coding key that correspond to a partial coding key may be specified using the at least one coding characteristic.

The determination of the various coding keys to be used in the subsequent encryption operations may further include determining at least one coding format instruction of the coding algorithm to be used in the respective encryption operation, said at least one coding format instruction defining a structure of the coding keys that can be used with the respective coding algorithm. Typical examples of such a coding format instruction are the minimum and maximum lengths of a usable coding key. The coding format instruction can then be used to determine the coding key to be used with the respective encryption operation.

According to an embodiment, at least one encryption operation may include the following steps: adding random data to the data packet to be encrypted prior to encryption. Using the data packet comprising the random data instead of the data packet to be encrypted. Creating a random data characteristic for the data packet to be encrypted that comprises the random data, said random data characteristic specifying a section filled with random data of the data packet to be encrypted that comprises the random data, and outputting the random data characteristic together with the data packet to be encrypted that comprises the random data.

As a result of adding random data, different encrypted data packets are obtained if an identical data packet is encrypted using an identical coding algorithm and an identical coding key in identical steps but at different points in time. Adding random data is thus used to conceal a coding algorithm and coding key used in the encrypted data packet. A section filled with random data can easily be identified in the data packet to be encrypted because of the random data characteristic used. The random data characteristic can optionally be output jointly for all encryption operations at the end of the last encryption operation or at the end of each encryption operation for the respective encryption operation. The random data characteristic can optionally be output separately from the data packet to be encrypted. Alternatively, the random data characteristic may also be added to the data packet to be encrypted.

To be able to check the integrity of the encrypted data packets during a subsequent decryption, at least one encryption operation prior to encryption may further include calculating a control value for the data packet to be encrypted and outputting the control value together with the data packet to be encrypted.

The control value is preferably calculated mathematically from the data packet to be encrypted. This can be done, for example, using a “hash algorithm” or “checksum algorithm”. The control value can optionally be output separately from the data packet to be encrypted. Alternatively, the control value may be added to the data packet to be encrypted. The control value can optionally be output jointly for all encryption operations at the end of the last encryption operation or at the end of each encryption operation for the respective encryption operation.

According to this invention, a method of decrypting plurally encrypted data packets of a data stream comprises the following steps: detecting at least one unencrypted coding characteristic assigned to the plurally encrypted data packet, said coding characteristic specifying at least one coding algorithm and an assigned coding key and sequentially decrypting the data packet to be decrypted in at least two subsequent decryption operations (decryption stages) using the at least one coding algorithm and assigned coding key specified in the at least one coding characteristic.

The coding characteristic can optionally be assigned explicitly (e.g. by referring to the assigned data packet) or implicitly (e.g. by a time correlation of receiving the coding characteristic and the encrypted data packet) to the encrypted data packet. As an alternative to a separate transfer of the coding characteristic, this characteristic may also be added in unencrypted form to the encrypted data packet.

The coding characteristic can be provided jointly for all decryption operations. In this case, the coding characteristic additionally specifies the sequence of the coding algorithms and assigned coding keys to be used.

Alternatively, the coding characteristic may also be provided separately for each decryption operation. In this case, each decryption operation may comprise the steps of detecting an unencrypted coding characteristic assigned to the respective data packet to be decrypted and of decrypting the data packet to be decrypted in the respective decryption operation using the coding algorithm and assigned coding key specified in the detected coding characteristic. It is therefore not required in this case that the coding characteristic explicitly specifies a sequence of the coding algorithms and assigned coding keys to be used.

At the end of each respective decryption operation, the decrypted data packet preferably matches the original data packet that was encrypted using the coding algorithm and coding key to form an encrypted data packet.

At least one decryption operation may include the following steps: detecting an unencrypted segmenting characteristic assigned to the data packet, said segmenting characteristic denoting data packets that are segments of a whole packet. Creating the whole data packet based on the decrypted data packets and the segmenting characteristic after decrypting and using the whole data packet instead of the data packet. Depending on the content of the segmenting characteristic, the steps listed above can optionally be performed in each decryption operation or after completing all decryption operations.

It may further be preferred that at least one decryption operation includes detecting an unencrypted block characteristic in the data packet after decryption, said block characteristic identifying a data packet to be used in the rest of the method.

This step can be included in each decryption operation. When using algorithms with the same block sizes, this step may alternatively be provided jointly for all decryption operations and performed after all decryption operations. This avoids inflation of the data packets by adding the block characteristic as the block characteristic is added just once to the data to be decrypted.

The method according to the invention may further include the steps of dividing a main coding key into multiple partial coding keys depending on the respective coding characteristic and assigning a partial coding key to each coding algorithm in each decryption operation depending on the respective coding characteristic. The advantages resulting from dividing a main coding key in several partial coding keys have been explained above.

In addition, at least one decryption operation may include the following: detecting an unencrypted random data characteristic assigned to the data packet wherein the random data characteristic specifies a section of the data packet filled with random data, and removing the random data from the data packet after decryption using the detected random data characteristic. Depending on the content of the random data characteristic, this step can optionally be performed in each decryption operation or jointly for all decryption operations after completing all decryption operations.

It may be preferable if at least one decryption operation after decryption also includes the steps of detecting a control value assigned to the data packet, calculating a check value using the data contained in the data packet, and comparing the control value with the check value. The data packet is preferably rejected when the control value does not match the check value as the integrity or proper decryption of the data packet is not ensured.

It is important to emphasize that the term “rejection” of the data packet should not be narrowly interpreted as meaning that the data packet is immediately deleted, for example. Alternatively, it may be sufficient to identify the data packet as faulty or to be rejected, e.g. by adding a marker. The decision about the further processing of a data packet carrying such a marker can be made later. The marked data packet may for example not be forwarded, not processed any further, or deleted.

It may be advantageous in general if the coding characteristic specifies the sequence of all coding algorithms with their associated coding keys used at the various encryption operations or decryption operations during sequential encryption or decryption, respectively. In this case the coding characteristic does not have to be provided separately for the various encryption operations or decryption operations, respectively. This prevents unnecessary inflation of the data to be processed due to issuing/adding the coding characteristic. In the simplest case, the sequence can be specified by simply listing the names that denote the coding algorithms.

It may be preferred if coding characteristic, segmenting characteristic, and random data characteristic for a data packet to be encrypted are output jointly as a collective characteristic.

Such a collective characteristic contains all the information that is important for encryption or decryption, respectively, and can be processed by a higher-order instance/device. The collective characteristic may optionally be provided separately for each encryption or decryption operation or jointly for all subsequent encryption or decryption operations.

In general, it can be arranged that an encrypted data packet received in a previous encryption operation of sequential encryption is the data packet to be encrypted in a subsequent encryption operation of sequential encryption. Accordingly, a data packet received in a previous encryption operation of sequential encryption can be the data packet to be decrypted in a subsequent encryption operation of sequential encryption.

A particularly high level of security is achieved if the various coding algorithms and/or coding keys are independent of each other. This means that the various coding algorithms and/or coding keys cannot be derived from each other by mathematical methods, for example.

Examples of suitable coding algorithms are Blowfish, AES, DES, 3DES, and Twofish. Examples of suitable coding keys are various random numbers. It is pointed out that this invention is not limited to these examples.

The object named above is also achieved by a signal sequence that causes the method according to any one of claims 1 through 10 to run if it is loaded into a data processor, particularly a microprocessor, of data processing unit. Such a signal sequence may be stored in the form of a computer program product on a data carrier or retrievable via a transmission network.

The object named above is further achieved using a data processing system in that the data processing system receives data packets of at least one data stream and processes the data packets based on a predefined instruction. The data processing system is programmed and set up according to the invention to execute the method according to any one of claims 1 through 10.

In this context the steps listed above may optionally be performed by a common data processing system or by higher-order or subordinate data processing systems. For example, a higher-order data processing system (i.e. a higher-order instance) may be provided that creates or detects the coding characteristic.

According to a first embodiment, the data processing system includes a storage unit in which at least two different coding keys are stored, at least two data processors, each comprising a permanently wired logic circuits, said logic circuits implementing different coding algorithms for processing a received data packet using a coding key, and a switching network to connect the data processors in series while the connection sequence can be changed. The data processing system further comprises a control unit that controls the switching network and the two or more data processors, at least receives the data packets of the data stream and forwards them to one of the two or more data processors, and reads different coding keys from the storage unit and issues them to the data processors.

Thus the data processing system according to the first embodiment may comprise multiple permanently wired logic circuits that can be switched flexibly and that each implement different coding algorithms, thereby causing encryption or decryption, respectively, of the data packets to be processed in steps configured to succeed each other in a circuit-oriented manner. It is pointed out that the storage unit may also be a simple input buffer (a buffer is a memory for intermediate data storage) for intermediate storage of coding keys received from a separate input interface. The storage unit does not have to be permanently integrated into the data processing system but may also be a separate storage medium that is connectable to the data processing system via an interface.

It may be preferred for this embodiment if each data processor comprises a buffer for intermediate storage of processed data packets, the size of such buffer depending on the respective use case of the data processing systems according to the invention.

If buffers are provided, the logic circuits can work independently from each other and thus at the same time. This way of parallel processing of different data packets in different logic circuits and processing stages is particularly important when it comes to processing data packets of a data stream as new data packets of the data stream have to be received and processed continuously.

The respective buffer can be adjusted to the respective was case of the data processing systems according to the invention in various ways. For example, it can be adjusted to the size of the data packets received by the data processing system of the invention from an external source (such as a transmission network or a computer program). As a coding algorithm implemented by the respective data processor can process only one preset block size, the system may also be adjusted to the block size of the respective coding algorithm.

According to a second embodiment, the data processing system includes a storage unit in which at least two different coding keys and at least two different coding algorithms are stored, at least two data processors, each comprising a programmable logic circuit for processing received data packets, and a connection network that connects the data processors in series to a preset sequence. The data processing system further includes a control unit that controls the at least two data processors, reads different coding algorithms from the storage unit, programs the logic circuits of the data processors accordingly, at least receives the data packets of the data stream and outputs them to a first of the at least two data processors, and reads different coding keys from the storage unit and outputs them to the data processors. The logic circuits of the respective data processors that are programmed according to a respective coding algorithm process the respective data packets received using the respective coding key received.

Thus the data processing system according to the second embodiment may comprise a multitude of logic circuits that are permanently wired in series but can be programmed freely. The storage unit may be an input buffer or a storage medium that can be connected to the data processing system via an interface in this embodiment as well. As the control unit programs and controls the logic circuits of the data processors according to various coding algorithms in such a way that the respective data processors process the respective data packets received using the respective coding key received, encryption or decryption of the data packets to be processed is caused in steps configured to succeed each other in a circuit-oriented manner.

It may be preferred that each data processor further comprises at least one input interface for receiving data packets to be processed and an output interface for outputting data packets processed wherein at least the output interface of the first data processor is connected via the switching network or the connection network to the input interface of a second data processor.

In other words, the control unit controls the switching network so that the various data processors are connected in series. As a result, the data to be processed runs subsequently through multiple data processors.

According to a third embodiment, the data processing system includes a storage unit in which at least two different coding keys and at least two different coding algorithms are stored and a data processor with a programmable logic circuit for processing data packets received. The data processing system further includes a control unit that at least receives the data packets of the data stream, reads different coding algorithms in chronological succession from the storage unit and programs the logic circuit of the data processors accordingly, reads different coding keys in chronological succession from the storage unit and forwards them together with the data to be processed to the data processor. The control unit further receives data processed by the data processor using the respective coding key and coding algorithm. The control unit outputs the processed data received from the data processor to the data processor at least once and controls it in such a way that the data processor processes a data packet to be processed received from the control unit at least twice in chronological succession using different coding algorithms and different coding keys.

Thus the data processing system according to the third embodiment may also comprise just one programmable data processor. In this case, the data packets to be processed are processed multiple times one after the other by the programmable logic circuit of the data processor using different coding algorithms and coding keys and thus are encrypted or decrypted in chronologically subsequent steps. The storage unit may be an input buffer or a separate storage medium that can be connected to the data processing system via an interface in this embodiment as well.

If the data to be processed is data to be encrypted, it may be preferred in all three embodiments that the control unit, when receiving a data packet to be encrypted, automatically determines a number, type, and—preferably—sequence, of different coding algorithms to be used in subsequent encryption operations (subsequent processing procedures by the at least one data processor which processing procedures are subsequent in a circuit-oriented manner or chronologically subsequent), determines different coding keys to be used in subsequent encryption operations, and assigns one respective coding key to one respective coding algorithm in one respective encryption operation. The control unit also controls the at least one data processor to obtain a plurally encrypted data packet. The control unit also automatically creates an unencrypted coding characteristic, said coding characteristic specifying at least the coding algorithm used last and the assigned coding key, and outputs the coding characteristic together with the plurally encrypted data packet.

The output of the coding characteristic may also be arranged in a way that the coding characteristic is implicitly or explicitly assigned to the respective data packet. The coding characteristic may optionally be output separately for each encryption operation in each encryption operation or jointly for all encryption operations at the end of the last encryption operation. As an alternative to a separate output, the control unit can automatically add the unencrypted coding characteristic it created to the respective encrypted data packet and make an assignment in this way.

If the data to be processed is data to be decrypted, however, it may be preferred in all three embodiments that the control unit, when receiving plurally encrypted data packets to be decrypted, automatically detects at least one unencrypted coding characteristic assigned to the data packet, said coding characteristic specifying at least one coding algorithm and one assigned coding key. The control unit then controls the at least one data processor so that it decrypts the data packet to be decrypted sequentially in at least two subsequent decryption operations using the at least one coding algorithm and assigned coding key specified in the at least one coding characteristic.

The coding characteristic may optionally be the same for all decryption operations or there may be a separate coding characteristic for each decryption operation. If the coding characteristic is the same for all decryption operations, it may be preferred that the coding characteristic specifies a sequence of the coding algorithms to be used.

Preferred embodiments of the invention are briefly described below with reference to the attached figures. As far as possible, the same or similar reference symbols were used in the figures to refer to the same or similar elements. Wherein:

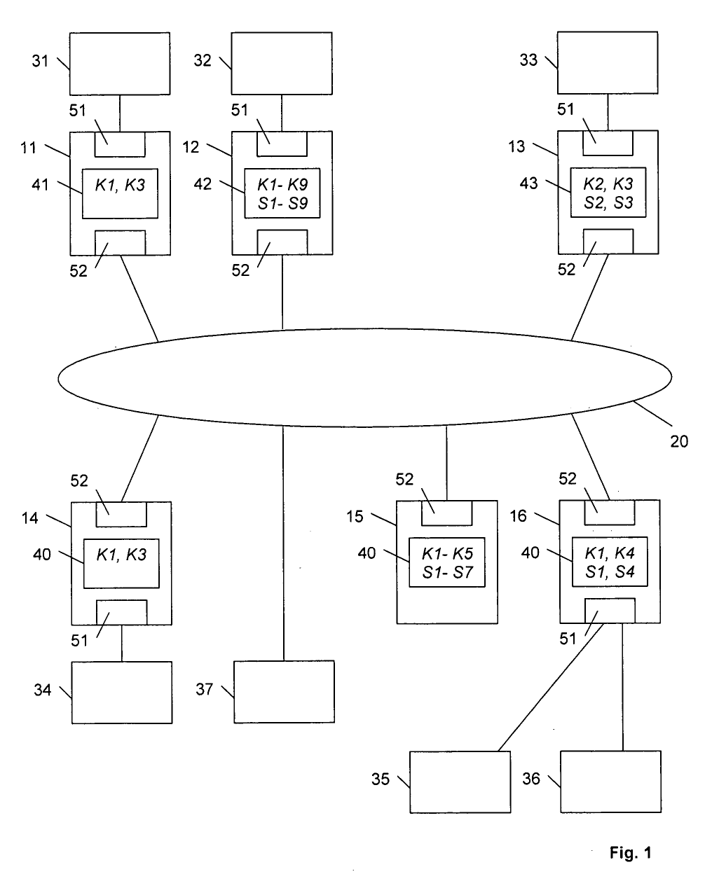

FIG. 1 schematically shows a configuration of a communication network in which the data processing system according to the invention is used;

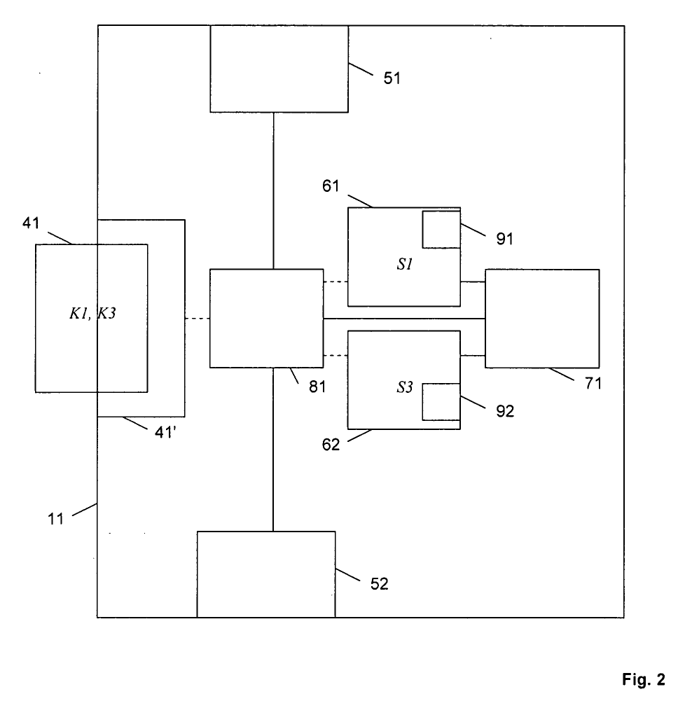

FIG. 2 schematically shows the configuration of a data processing system according to a first preferred embodiment of this invention;

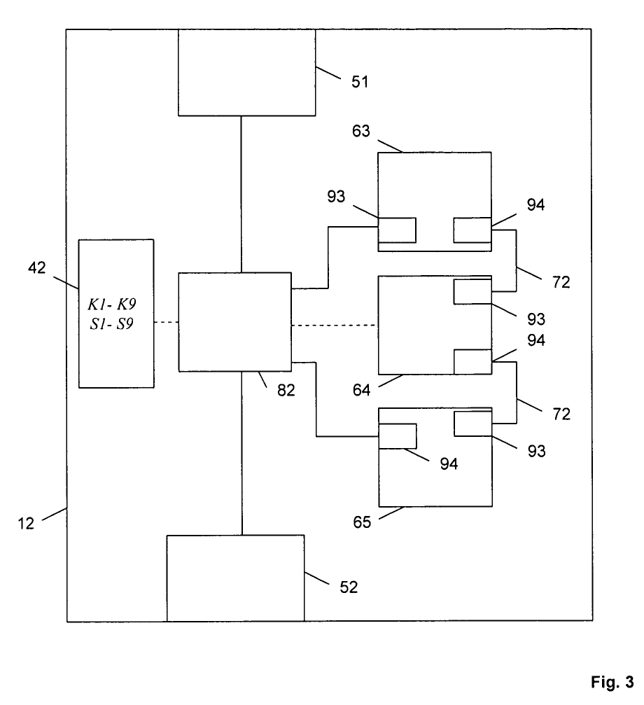

FIG. 3 schematically shows the configuration of a data processing system according to a second preferred embodiment of this invention;

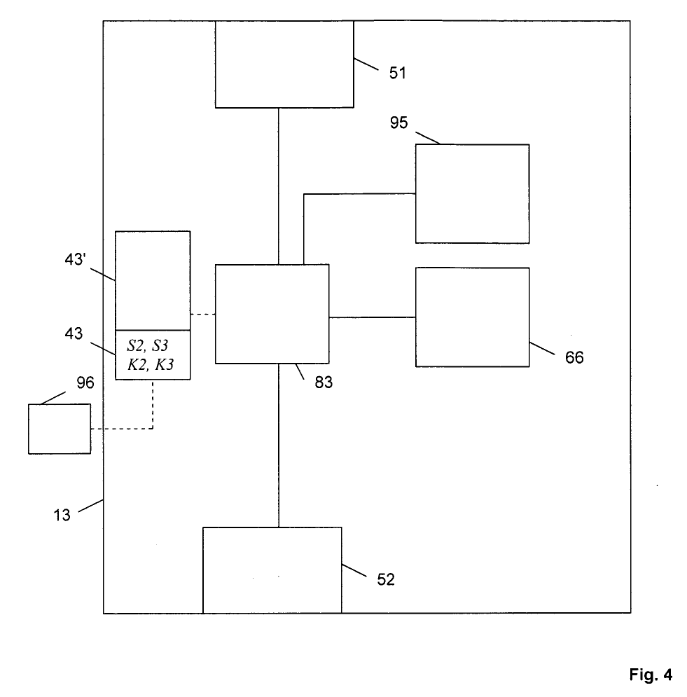

FIG. 4 schematically shows the configuration of a data processing system according to a third preferred embodiment of this invention;

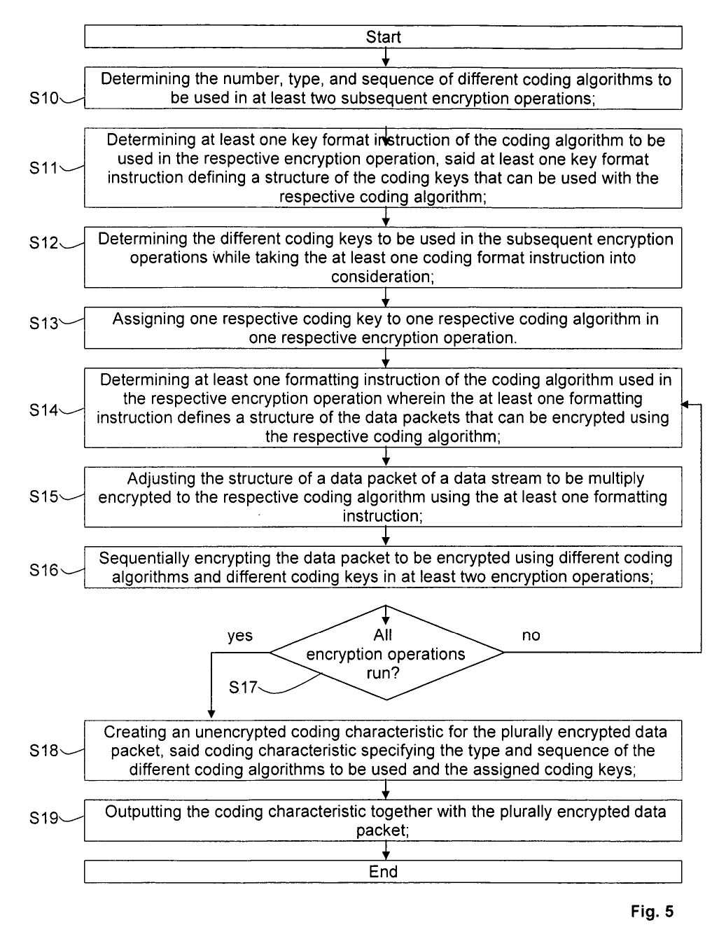

FIG. 5 shows a flow chart of a preferred embodiment of the method according to the invention of encrypting data packets of a data stream;

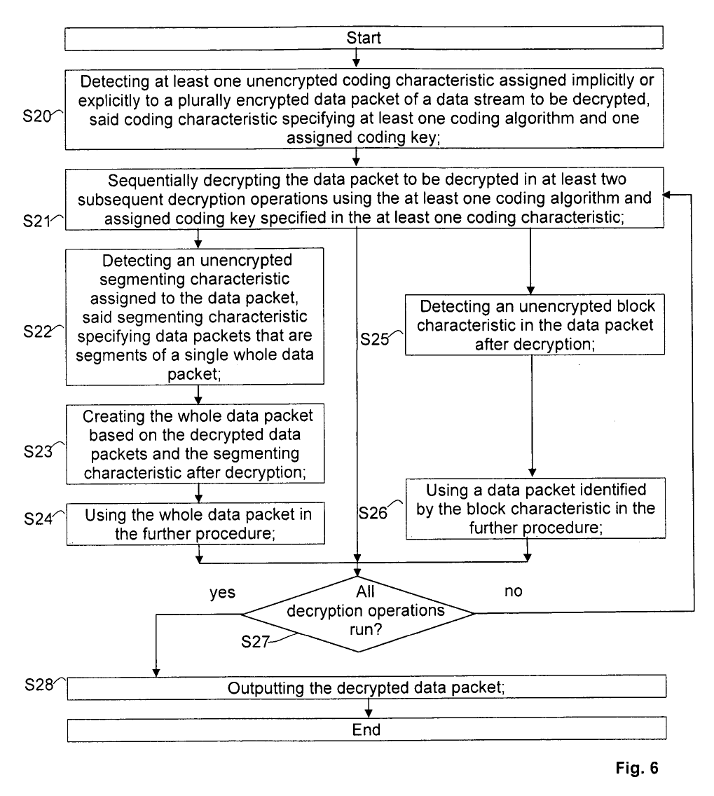

FIG. 6 shows a flow chart of a preferred embodiment of the method according to the invention of decrypting plurally encrypted data packets of a data stream; and

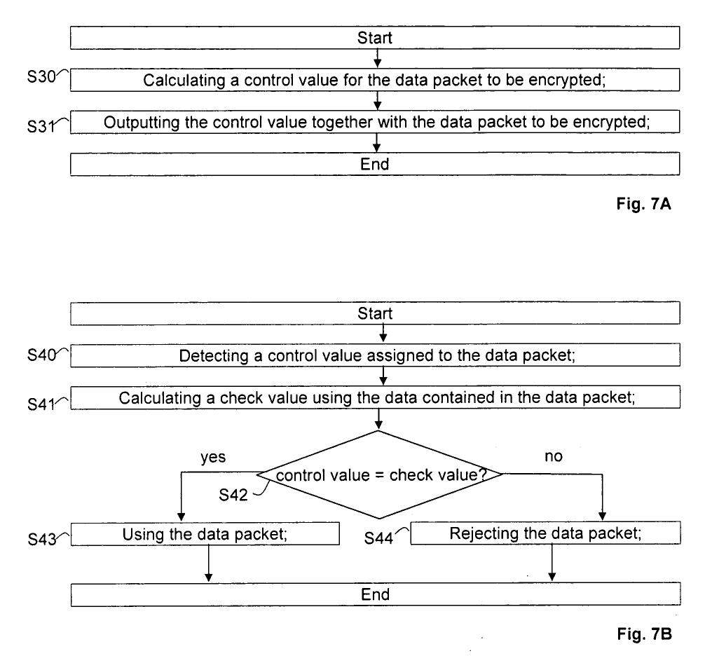

FIG. 7A,

FIG. 7B each show a flow chart depicting the use of a control value.

Preferred embodiments of the method according to the invention and of the data processing system according to the invention are described below with reference to the attached figures. As the data processing system of the invention is expressly programmed and set up to execute the method according to the invention, the device and method are discussed jointly.

The data processing systems according to the invention are particularly well suited for use in a communication network as shown in FIG. 1.

In this communication network, a multitude of communication interfaces 31, 32, 33, 34, 35, 36, 37 are interconnected for mutual data exchange via a transmission network 20. In the example shown, communication interfaces 31-37 are personal computers and the transmission network 20 is a TCP/IP network.

One data processing system according to the invention 11, 12, 13, 14, 16 each is placed between the communication interfaces 31-36 and the transmission network 20. The data processing systems 11-14, 16 each comprise two interfaces 51 and 52 for connecting to the transmission network 20 or the communication interfaces 31-36, respectively. The data packets received are processed in the data processing systems 11-16 according to a predefined instruction, which is explained in detail below.

The data processing system 15 in this example is a personal computer itself and therefore not specially connected to a communication interface.

Each data processing system 11-16 comprises a storage unit 40, 41, 42, 43 in each of which at least two different coding keys K1-K9 are stored. Depending on the design of the data processing systems 11-16, a minimum of two different coding algorithms S1, S2, S3 may additionally be stored in the storage unit 40, 41, 42, 43. In the examples below, the different coding keys K1-K9 are predefined random data and the different coding algorithms S1, S2, S3 are the “Blowfish”, “AES”, and “Twofish” algorithms. Any other, preferably conventional standardized algorithms may be used.

A comparable communication network is described in patent application DE 10 2005 046 462 filed on Sep. 21, 2005 to the full content of which this document expressly refers. The data processing systems 11-16 of the invention are preferably integrated into the network components described in said patent application. It can be advantageous in this case that the data processing systems 11-16 do not process complete data packets (that is packets containing a protocol data part and a user data part) of the data stream but only user data parts.

A data processing system according to a first preferred embodiment of this invention is described below with reference to FIG. 2.

In addition to storage facilities 41, 41′ and interfaces 51, 52, the data processing system 11 comprises two data processors 61, 62, a switching network 71, and a control unit 81.

As mentioned above, the interfaces 51, 52 are used to receive or output data packets of a data stream and thus to connect the data processing system 11 with the transmission network 20 or the communication interface 31, respectively.

In the embodiment shown in FIG. 2, the storage unit is formed by a smart card 41 and thus by a portable non-volatile storage medium on which two different coding keys K1, K3 are stored. The smart card 41 can be connected to the data processing system 11 via a memory interface 41′. The data processing system 11 can be provided different coding keys by replacing the smart card 41.

The two data processors 61, 62 each comprise a hard-wired logic circuit in form of an FGPA (field programmable gate array) that implement the different coding algorithms S1, S3, “Blowfish” and “Twofish”. In addition, each data processor 61, 62 comprises a buffer 91, 92 for the intermediate storage of processed data packets. The size of the buffers 91, 92 is adjusted to the size of the data packets the data processing system of the invention receives from the transmission network 20 or the communication interface 31 (e.g. 1500 characters). This invention is not limited to this, however. For example, the size may also be adjusted to a maximum block size of the data packets that can be processed using the respective implemented coding algorithm S1, S3 (e.g. 64 characters or 128 characters).

The two data processors 61, 62 can optionally be connected in series via the switching network 71. In the example discussed, the switching network 71 can interlink the data processors 61, 62 in such a way that optionally a sequence of data processor 61 followed by data processor 62 or a sequence of data processor 62 followed by data processor 61 results.

The control unit 81, in this example a microprocessor, controls the switching network 71 and the two data processors 61, 62. FIG. 2 shows the control of the two data processors 61, 62 (e.g. by transferring coding keys K1, K3) as a dashed line, while the solid lines represent connections via which the data packets (and control commands, if any) are transported. The control unit 81 further receives the data packets of the data stream to be processed via interfaces 51, 52.

Upon reception of a data packet to be encrypted from the communication interface 31 via interface 51, the control unit 81 automatically determines (S10) the sequence of the different coding algorithms S1, S3 to be used in the subsequent encryption operations and thus the switching of the two data processors 61, 62 required for encryption. In this case, the data processors are to be linked using the switching networks 71 so that the data processor 62 precedes the data processor 61. The control unit 81 reads the two different coding keys K1, K3 via the memory interface 41′ from the smart card 41 and outputs one respective of the two coding keys K1, K3 to one of the two data processors 61, 62 (S13). As the two data processors 61, 62 each only implement one coding algorithm S1, S3 durably, the control unit 81 can easily select a suitable key length. The control unit 81 determines the coding keys K1, K3 to be used in the subsequent encryption operations accordingly (S12). The coding keys K1, K3 are each assigned to a coding algorithm S1, S3 of a data processor 61, 62 and to an encryption operation (S13).

Based on the defined coding algorithms S1, S3, the control unit 61 then automatically determines a formatting instruction (S14) for each coding algorithm S1, S3 that defines a structure of the data packets that can be encrypted using the respective coding algorithm S1, S3. The control unit 61 automatically adjusts the structure of the data packet to be encrypted using the at least one formatting instruction in this embodiment so that the data packet complies with the formal rules of both coding—algorithms S1, S3 (S15).

If the data packets to be encrypted are greater than a defined maximum data packet size or if the data packets encrypted by the first data processor 61 will become greater than the defined maximum data packet size, this adjustment of the data packet to be encrypted includes segmenting the data packet to be encrypted into multiple partial data packets and using the partial data packet instead of the data packet to be encrypted. In this case, the control unit 61 automatically creates an unencrypted segmenting characteristic that denotes partial data packets obtained by segmenting a single data packet. In the embodiment shown, the control unit 61 automatically adds the segmenting characteristic to the respective segmented partial data packets and outputs them together with the segmenting characteristic.

If the size of the buffers 91, 92 (unlike in this embodiment) is adjusted to the maximum block size that can be processed at once by the coding algorithms S1, S3 implemented by the data processors 61, 62, segmenting may occur, for example, if the data packets to be encrypted are greater than the block size of the coding algorithms or will be after encryption by the first data processor 61.

If the size of a data packet to be encrypted does not equal a multiple of the maximum processable block size of the respective coding algorithm, adjustment includes that the control unit 61 fills the data packet to be encrypted with characters at its end until the next multiple of the block size is reached. At the same time, the control unit 61 creates a block characteristic that identifies the data packet to be encrypted in the data block and adds this characteristic to the data block. Then the control unit 61 uses this adjusted data block instead of the data packet to be encrypted.

Then the control unit 81 outputs the data packet to be encrypted via the switching network 71 to the first of the two data processors 61, 62. After encryption, the first data processor 62 outputs the singly encrypted data packet via the switching network 71 to the second data processor 61. After encryption, the second data processor 62 outputs the doubly encrypted data packet via the switching network 71 to the control unit 81. This causes sequential encryption of the data packet (S16). As the data processors 61, 62 are hard-wired in series, it is not necessary to check if all encryption operations were executed (S17).

The control unit 81 automatically creates an unencrypted coding characteristic assigned to the doubly encrypted data packet that uniquely specifies the type and sequence of the coding algorithms S3, S2 and assigned coding keys K3, K1 used by the data processors 61, 62 (S18). In the example discussed here, the information is specified by the word “Two3Blow1” that stipulates that the data was first encrypted using the Twofish coding algorithm S3 and the coding key K3, then using the Blowfish coding algorithm S1 and the coding key K1. Thus the coding characteristic along with the coding algorithms and coding keys facilitates decryption of the data.

Finally the control unit 81 outputs the coding characteristic at the same time as the doubly encrypted data packet via the interface 52 to the transmission network 20 (S19) and in this way makes an implicit assignment to the encrypted data packet. Alternatively, the assignment may be explicit.

When receiving a doubly encrypted data packet to be decrypted by the transmission network 20 via the interface 52, the control unit 81 automatically detects an unencrypted coding characteristic assigned to the data packet (S20) that specifies the type and sequence of the coding algorithms and coding keys used during encryption. In this example, it is assumed that the coding characteristic is “Two3Blow1” to specify that the data packet was first encrypted using the Twofish coding algorithm S3 and the coding key K3 and then using the Blowfish coding algorithm S1 and the coding key K1. It is obvious that the decryption has to be in reverse order.

Alternatively, the coding characteristic can be a more abstract representation (such as a numeric code).

Both the two coding algorithms S1, S3 and the two coding keys K1, K3 are known to the data processing system 11 of the invention in this example. Otherwise, decryption using the data processing system 11 would not be possible.

Depending on the coding characteristic, the control unit 81 controls the switching network 71 so that the data processors 61, 62 are connected in series and outputs the data packet to be decrypted via the switching network 71 to the first of the two data processors 61, 62. After decryption using the Blowfish coding algorithm and coding key K1, the first data processor 61 outputs the singly decrypted data packet via the switching network 71 to the second data processor 62. After decryption using the Twofish coding algorithm and coding key K3, the second data processor 62 outputs the doubly decrypted data packet via the switching network 71 to the control unit 81. Thus, the doubly encrypted data packet was decrypted sequentially based on the coding characteristic in two subsequent decryption operations using different coding algorithms and different coding keys (S21).

Then the control unit 81 checks if another characteristic such as a segmenting characteristic or a block characteristic is assigned to the decrypted data in addition to the coding characteristic (S22, S25). In the example discussed here, the assignment is made explicitly together with the coding characteristic in a separate data record that contains the other characteristics. Alternatively, these other characteristics may be added and assigned directly to the data packets.

If no other characteristic is assigned to the decrypted data, the control unit 81 outputs the doubly decrypted data packet via the interface 51 to the assigned communication interface 31 (S28).

If the control unit 81 however detects an unencrypted segmenting characteristic assigned to the data packet, said segmenting characteristic identifying data packets that are segments of a whole data packet (S22), the control unit 81 first forms the whole data packet based on the decrypted data packets and the segmenting characteristic (S23). Then the control unit 81 uses the whole data packet instead of the decrypted data packet (S24) and outputs the same via the interface 51 to the assigned communication interface 31 (S28).

If the control unit 81 however detects an unencrypted block characteristic assigned to the data packet, said block characteristic identifying a data packet to be used in the further procedure in the data packet (S25), the control unit 81 uses the data packet identified by the block characteristic (S26) and outputs the same via the interface 51 to the assigned communication interface 31(S28).

It is obvious that the use of the coding characteristic is dispensable when the data processors are durably linked in a defined sequence and the different coding keys are permanently assigned to the data processors. It suffices in such a case to use data processing systems with an identical structure for encryption and decryption. Even if the coding characteristic is dispensable here, it may optionally be required to use the segmenting characteristic and/or block characteristic. The reason is that these characteristics cannot be derived from the structure of the data processing system.

The structure of a data processing system according to a second preferred embodiment of this invention is described below with reference to FIG. 3. This description only discusses aspects that differ from the first embodiment.

Unlike the first embodiment, the storage unit 42 of the data processing system 12 of this embodiment is a non-volatile memory that is permanently integrated into the data processing system 12 in the form of an EEPROM 42. Different coding algorithms S1-S9 are stored in this EEPROM 42 in addition to different coding keys K1-K9. The coding keys K1-K9 are not stored individually in the EEPROM but in form of a main coding key in which the control unit 82 can define different sections that make up a (partial) coding key K1-K9. These (partial) coding keys K1-K9 are used during encryption or decryption. Accordingly, the coding characteristic denotes those sections of the main coding key used to specify the coding key during encryption.

Unlike the first embodiment, the data processing system 12 of the second embodiment comprises three data processors 63, 64, 65 with one programmable logic circuit each for processing data packets received. The data processors 63, 64, 65 in the embodiment are microprocessors that can be programmed and set up to implement and execute the coding algorithms S1-S9. Instead of the switching network 71 provided in the first embodiment, a connection network 72 is provided that connects the data processors 63, 64, 65 in series in a predefined order. The data processors 63, 64, 65 are interconnected in such a way via the connection network 72 that an input interface 93 of a first data processor 63 is connected to the control unit 82, an output interface 94 of the first data processor 63 is connected to an input interface 93 of a second data processor 64, an output interface 94 of the second data processor 64 to an input interface 93 of a third data processor 65 and an output interface 94 of the third data processor 65 to the control unit 82.

Consequently, the control unit 82 in this embodiment does not determine the sequence of the coding algorithms to be used via the connection sequence of the data processors 63, 64, 65 but by the respective programming of the data processors 63, 64, 65. The control unit 82 reads three different coding algorithms S1, S2, S3 from the storage unit 42 and programs the logic circuits of the data processors 63, 64, 65 accordingly (S10). The control unit 82 further reads three different coding keys K1, K2, K3 from the storage unit 42 and assigns one coding key K1, K2, K3 to one data processor 63, 64, 65 (S13).

For processing, the control unit outputs a data packet of a data stream received via the interfaces 51, 52 to the input interface 93 of the first data processor 63. The data processors 63, 64, 65 process the data packet so that a data packet received from a preceding data processor 63 becomes the data packet to be processed in the succeeding data processor 64 (S16).

The processing of the data packets by the data processors 63, 64, and 65 does not differ from the processing by the data processors 61, 62 of the first embodiment.

As in the first embodiment, the control unit 82 can segment data packets or process a segmenting characteristic and process data blocks as well as a block characteristic.

In addition, the control unit 82 in this embodiment automatically reads from the storage unit 42 a coding format instruction of the coding algorithms to be used for assigning the coding keys K1, K2, K3 to the coding algorithms S1, S2, S3 (S11) that specifies the structure of the respective coding key that can be used with the respective coding algorithm.

This coding format instruction is used by the control unit 82 when determining the partial coding keys K1, K2, K3 from the main coding key (S12) and thus when assigning the different coding keys K1, K2, K3 to the respective coding algorithms S1, S2, S3 (S13). In this example, the coding format instruction specifies the maximum key length of the respective coding key K1, K2, K3 permissible for the respective coding algorithm S1, S2, S3.

The structure of a data processing system according to a third preferred embodiment of this invention is described below with reference to FIG. 4. This description only discusses aspects that differ from the first and/or second embodiment.

Unlike the preceding embodiments, the storage unit in this embodiment consists of a non-volatile EEPROM 43 that is permanently integrated into the data processing system 13 and in which at least two different coding algorithms S2, S3 and two different coding keys K2, K3 are stored, and a buffer 43′. The coding algorithms S2, S3 and the coding keys K2, K3 are loaded into the buffer 43′ if a user uses an input element (in this example, a keyboard 96) connected to the data processing system 13 to release them by entering a secret number such as a PIN (personal identification number).

Alternatively, it is also possible that the user enters the coding key directly using the input element. The coding keys do not need to be permanently stored in the data processing system according to the invention in this case.

In this embodiment only one data processor 66 is provided with a programmable logic circuit. As in the two preceding embodiments, the data processor 66 is designed to be set up in such a way that it processes a data packet received according to a predefined coding algorithm S2, S3 and assigned coding key K2, K3.

The functioning of the control unit 83 also generally matches the functioning of the control units known from the preceding embodiments.

Unlike in preceding embodiments, the control unit 83 causes a sequential processing of a data packet using different coding algorithms and assigned different coding keys (S16, S21) in that it reads a first coding algorithm S2 and a first assigned coding key K2 from the storage unit 43, 43′ and programs the logic circuit of the data processor 66 accordingly. The control unit 83 then outputs the data packets to be processed to the data processor 66 and controls it in such a way that the data packets are processed using the first coding algorithm S2 and the first assigned coding key K2 first. The control unit 83 intermediately stores the processed data in a buffer memory 95 connected to it. Then the control unit 83 reads another coding algorithm S3 different from the previously used coding algorithm S2 and another coding key K3 different from the previously used coding key K2 from the storage unit 43, 43′ and programs the logic circuit of the data processor 66 accordingly. Then the control unit 83 outputs the data packets intermediately stored in the buffer memory 95 to the data processor 66 and controls it in such a way that it processes the data packets using the new coding algorithm S3 and the newly assigned coding key K3. The control unit 83 then again intermediately stores the processed data in the buffer memory 95. The control unit 83 repeats this procedure until the desired number of processing steps is reached. This can be monitored using a counter, for example.

Unlike in the preceding embodiments, the control does not form the coding characteristic (S18) at the end of processing but individually for each processing step the data processor 66 performs. The control unit 83 also does not output the coding characteristic separately at the end (S19) but adds it to the processed data packet immediately in each processing step. In this case the coding characteristic does not have to specify the sequence of the coding algorithms and assigned coding keys explicitly. The coding characteristic instead just specifies the coding algorithm and assigned coding key used in the respective processing step. The control unit 83 has the data processor 66 process the other characteristics within each processing step and adds them to the processed data packets.

When a data packet is encrypted, the control unit 83 automatically adds random data to the data packet to be encrypted prior to outputting the data packet to be encrypted to the data processor 66. The control unit 83 automatically creates a random data characteristic that specifies a section filled with random data of the data packet to be encrypted that comprises the random data and adds it to the data packet to be encrypted. Accordingly, during a decryption of a data packet, the control unit 83 automatically detects an unencrypted random data characteristic assigned to the data packet after each decryption and removes the random data automatically using the detected random data characteristic from the data packet.

In addition, the control unit 83 automatically calculates a control value for the data packet to be encrypted (S30) prior to each output of the data packet to be encrypted to the data processor 66 and adds this control value to the data packet to be encrypted (S31). This is shown in FIG. 7A. A hash algorithm is used in the embodiment described here.

Accordingly, the control unit 83 automatically detects a control value assigned to the data packet during a decryption (S40) and calculates a check value for the decrypted data packet using data contained in the data packet (S41). Then the control unit compares the control value with the check value (S42). The control unit 83 marks the data packet automatically as to be rejected if the control value does not match the check value (S44). Otherwise the data packet is used further and may be output, for example, to the data processor 66 or to the communication interface 33 via the interface 51 (S43). This is shown in FIG. 7B.

Even if the use of the control value has only been described for the third embodiment, this invention is not limited to same. It is obvious that both the control value and the various characteristics such as the coding characteristic, the segmenting characteristic, the block characteristic, and the random data characteristic can be used simultaneously or optionally in all three embodiments. Furthermore, the control value or characteristics may be used in each of the subsequent processing steps or just in one of the subsequent processing steps (such as the first or last processing step).

The data processing systems in the embodiments described above only received and processed user data packets. If data packets are to be processed that contain both a protocol data part and a user data part, it is preferred that the respective control unit automatically adjusts the encrypted data packet or the decrypted data packet prior to outputting the encrypted data packet as plurally encrypted data packet or the decrypted data packet as plurally decrypted data packet to a format of the unencrypted data packet received or the encrypted data packet received, respectively. In the simplest case it is sufficient to adjust the protocol data part to the new size of the user data part.

The different coding algorithms and coding keys are independent from each other in all three embodiments. This means that two or more coding algorithms two or more coding keys cannot be mathematically derived from each other without knowing all coding algorithms or coding keys. This does not rule out that a mathematical connection among the respective coding keys or coding algorithms may be established in retrospect or may accidentally arise when knowing two coding keys or coding algorithms.

The method according to the invention can be performed well by a signal sequence and thus a computer program product that causes the execution of the method according to any one of claims 1 through 10 if it is loaded into a microprocessor of a data processing system. This provides easily configurable and strong encryption.

Even if the use of a multitude of different characteristics has been described above, the invention is not limited to these characteristics. For example, an encryption or decryption operation may additionally involve setting an initializing vector for the respective coding algorithm depending on a coding algorithm used.

In addition, the division of processing among the respective control unit and the respective at least one data processor is not static but may be changed.

Even though the control unit, the at least one data processor, the interfaces, the storage unit and the switching network or connection network have been described as separate elements in all three embodiments, several or even all elements may be integrated into a joint semiconductor block such as a microprocessor.

The data processing system according to the invention may also be integrated as a whole into a higher-order system such as a personal computer, a digital telephone or fax machine, a modem, a network card or the like. In this case it may be preferred that the data processing system of the invention works independently of the operating system of the higher-order system. This ensures the operating capability of the data processing system separately from the higher-order system.

As an alternative to permanent storage of different coding keys and/or different coding algorithms in a storage unit, the different coding keys and/or different coding algorithms stored in the storage unit may also be replaced as part of a maintenance operation which may also be a remote maintenance operation. Such replacement can also be performed by storing the coding algorithms and/or coding key on a removable storage medium. The coding algorithms and/or coding keys can then simply be replaced by changing the storage medium. This makes the data processing system of the invention easily adaptable if, for example, the security of a coding key or coding algorithm was breached. Of course, there can be any number (greater than or equal to 2) of different coding keys and any number (greater than or equal to 2) of different coding algorithms.

It is further pointed out that the data processing system may comprise additional memories and auxiliary elements (not shown) such as a power supply unit to support the operability of the data processing system according to the invention.

The embodiments described above have further been described using symmetrical coding keys and coding algorithms. This also results in symmetry of the various characteristics, in particular, the coding characteristic. This invention is not limited to this, however. Instead, asymmetrical coding keys and coding algorithms may be used. As a result, we have to distinguish between encryption coding keys and decryption coding keys as well as encryption coding algorithms and decryption coding algorithms. It is obvious to an expert skilled in the art that the various characteristics have to be adjusted to this asymmetry accordingly. As an expert skilled in the art does not have to deviate from the principle of the solution described above but would just have to adjust it accordingly, no separate description is deemed necessary.

To summarize, this invention relates to a method of encrypting data packets of a data stream and decrypting plurally encrypted data of a data stream that provides an increased security level of the encryption and can be automated using a signal sequence (a computer program product) or a data processing device. A data packet to be encrypted or a data packet to be decrypted is automatically encrypted or decrypted sequentially in at least two subsequent processing steps (processing stages) using different coding algorithms and different assigned coding keys. This results in encryption or decryption that depends on the sequence of the processing steps and provides increased security of the data.

It is preferred that the method is opaque to external parties. It is therefore preferred that the process that goes on inside a data processing system of the invention cannot be detected from the outside. Instead, the data processing system preferably presents itself as a “black box” that receives data to be processed and optionally receives coding keys and/or coding algorithms as well as optional additional data (characteristics) and outputs processed data and optionally additional data (characteristics).

The interfaces of the data processing systems according to the invention preferably are no different from conventional encrypters/decrypters that use the coding algorithm that was used in the first processing step of the data processing system. This makes the modular use of the data processing system of the invention easier. If viewed from the outside, the at least two subsequent processing steps appear like a new encryption algorithm with increased capabilities. Accordingly, the coding characteristic can specify the name of the new encryption algorithm.

The high level of data security achieved makes the data processor according to the invention and the method according to the invention as well as the signal sequence according to the invention particularly suited for use in a mobile/external communication situation with sensitive transmission networks such as the transmission networks of banks or government authorities.

As at least two different coding algorithms and different assigned coding keys are used sequentially, the solution according to the invention provides sufficient data security if one of the at least two coding algorithms and/or coding keys used has become vulnerable. This drastically reduces the risk of obsolescence when implemented in hardware.

It is emphasized that this invention is not limited to the embodiments described above and that numerous variations are conceivable without having to deviate from the solution claimed.

In other words, present invention provides a method of encrypting data packets of a data stream by which a data packet to be encrypted is automatically encrypted sequentially in at least two subsequent encryption operations (encryption stages or encryption steps), a corresponding method of decrypting data packet, a signal sequence that causes these methods to be executed when loaded into a data processor of a data processing system, and, finally, a data processing system for correspondingly handling the data packets, as follows:
1. A method of encrypting data packets of a data stream wherein a data packet to be encrypted is automatically encrypted sequentially in at least two subsequent encryption operations, comprising the following steps:
   determining the number, type, and sequence of different coding algorithms to be used in the subsequent encryption operations;
   determining the different coding keys to be used in the subsequent encryption operations;
   assigning one respective coding key to one respective coding algorithm in one respective encryption operation; and
   sequentially encrypting a data packet to be encrypted in at least two subsequent encryption operations to obtain a plurally encrypted data packet.
2. The method of item 1, further including the following steps:
   creating an unencrypted coding characteristic for the plurally encrypted data packet, said coding characteristic at least specifying the latest coding algorithm used and the assigned coding key; and
   outputting the coding characteristic together with the plurally encrypted data packet.
3. The method according to item 2, further including:
   adding the created unencrypted coding characteristic in each encryption operation to the respective encrypted data packet after encryption.
4. The method according to any one of the preceding items,
   each encryption operation including:
   determining at least one formatting instruction of the coding algorithm used in the respective encryption operation wherein the at least one formatting instruction defines a structure of the data packets that can be encrypted using the respective coding algorithm; and
   adjusting the structure of the data packet to be encrypted to the respective coding algorithm using the at least one formatting instruction.
5. The method according to item 4 wherein adjusting the data packet to be encrypted includes:
   segmenting the data packet to be encrypted into several partial data packets to be encrypted;
   using the partial data packets instead of the data packet to be encrypted.
   creating an unencrypted segmenting characteristic for the partial data packets to be encrypted wherein the segmenting characteristic identifies partial data packets obtained by segmenting a single data packet; and
   outputting the segmenting characteristic together with the segmented partial data packets to be encrypted.
6. The method according to one of items 4 or 5, wherein adjusting the data packet to be encrypted includes:
   creating a data block, said data block containing the data packet to be encrypted and a block characteristic, wherein the block characteristic identifies the data packet to be encrypted in the data block; and
   using the data block instead of the data packet to be encrypted.
7. The method according to any one of the preceding items further including:
   dividing a main coding key into multiple different partial coding keys; and
   assigning one respective partial coding key to one respective coding algorithm in one respective encryption operation.
8. The method according to any one of the preceding items wherein determining the different coding keys to be used in the subsequent encryption operations includes:
   determining at least one key format instruction of the coding algorithm to be used in the respective encryption operation, said at least one key format instruction defining a structure of the coding key that can be used with the respective coding algorithm; and
   taking the coding format instruction into consideration when selecting the coding key to be used in the respective encryption operation.
9. The method according to any one of the preceding items wherein at least one encryption operation includes the following steps:
   adding random data to the data packet to be encrypted prior to encryption;
   using the data packet comprising the random data instead of the data packet to be encrypted;
   creating a random data characteristic for the data packet to be encrypted that comprises the random data, said random data characteristic specifying a section filled with random data in the data packet to be encrypted that comprises the random data; and
   outputting the random data characteristic together with the data packet to be encrypted that comprises the random data.
10. The method according to any one of the preceding items wherein at least one encryption operation further includes the following steps prior to encryption:
   calculating a control value for the data packet to be encrypted; and
   outputting the control value together with the data packet to be encrypted.
11. A method of decrypting plurally encrypted data packets of a data stream comprising the following steps:
   detecting at least one unencrypted coding characteristic assigned to the plurally encrypted data packet, said coding characteristic specifying at least one coding algorithm and one assigned coding key; and
   sequentially decrypting the data packet to be decrypted in at least two subsequent decryption operations using the at least one coding algorithm and assigned coding key specified in the at least one coding characteristic.
12. The method according to item 11 wherein at least one decryption operation includes the following steps:
   detecting an unencrypted segmenting characteristic assigned to the data packet, said segmenting characteristic specifying data packets that are segments of a single whole data packet;
   creating of the whole data packet based on the decrypted data packets and the segmenting characteristic after decryption; and
   using the whole data packet instead of the data packet.
13. The method according to one of items 11 or 12 wherein at least one decryption operation includes:
   detecting an unencrypted block characteristic in the data packet after decryption, said block characteristic in the data packet identifying a data packet to be used in the further procedure.
14. The method according to any one of items 11 through 13,
   further including:
   dividing a main coding key into several different partial coding keys depending on the respective coding characteristic; and
   assigning one respective partial coding key to one respective coding algorithm in one respective decryption operation depending on the respective coding characteristic.
15. The method according to any one of items 11 through 14,
   wherein at least one decryption operation includes the following steps:
   detecting an unencrypted random data characteristic assigned to the data packet, said random data characteristic specifying a section of the data packet filled with random data; and
   removing the random data from the data packet after decrypting using the detected random data characteristic.
16. The method according to any one of items 11 through 15 wherein at least one decryption operation comprises the following steps after decryption:
   detecting a control value assigned to the data packet;
   calculating a check value using the data contained in the data packet;
   comparing the control value with the check value; and
   rejecting the data packet if the control value does not match the check value.
17. The method according to any one of items 2 through 16 wherein the coding characteristic specifies the sequence of all coding algorithms with their associated coding keys used at the various encryption operations or decryption operations during sequential encryption or decryption, respectively.
18. The method according to any one of items 2 through 17 wherein the coding characteristic, segmenting characteristic, and random data characteristic for a data packet to be encrypted are output jointly as a collective characteristic.
19. The method according to any one of the preceding items wherein an encrypted data packet obtained within a preceding encryption operation of sequential encryption is the data packet to be encrypted in a subsequent encryption operation of sequential encryption and/or a data packet obtained within a preceding decryption operation of sequential decryption is the data packet to be decrypted in a subsequent decryption operation of sequential decryption.
20. The method according to any one of the preceding items wherein the different coding algorithms and/or coding keys are independent of each other.
21. A signal sequence that causes the execution of the method according to any one of items 1 through 20 if it is loaded into a data processor, in particular a microprocessor, of a data processing system.
22. A data processing system,
   said data processing system at least receiving data packets of a data stream and processing the data packets received in accordance with a predefined instruction,
   characterized in that
   the data processing system is programmed and set up to execute the method according to any one of items 1 through 20.
23. The data processing system according to item 22, including
   a storage unit in which at least two different coding keys are stored;
   at least two data processors, each of which comprising a hard-wired logic circuit, said logic circuit implementing respective different coding algorithms for processing a data packet received using a coding key;
   a switching network to optionally connect the data processors in series, the connection sequence of the two being changeable; and
   a control unit that controls the switching network and the at least two data processors, at least receives the data packets of the data stream and outputs them to a first of the at least two data processors, reads different coding keys from the storage unit and outputs them to the data processors.
24. The data processing system according to item 23 wherein each data processor comprises a buffer for intermediate storage of processed data packets, the size of the buffer depending on the respective application case of the data processing system according to the invention.
25. The data processing system according to item 22, including
   a storage unit in which at least two different coding keys and at least two different coding algorithms are stored;
   at least two data processors, each of which comprising a programmable logic circuit for processing data packets received;
   a connection network that connects the data processors in series in a predefined order; and
   a control unit that controls the at least two data processors, reads different coding algorithms from the storage unit and programs the logic circuits of the data processors accordingly, at least receives the data packets of the data stream and outputs them to a first of the at least two data processors, and reads different coding keys from the storage unit and outputs them to the data processors
   wherein the logic circuits of the respective data processor programmed according to a respective coding algorithm process the data packets received using the respective coding key received.
26. The data processing system according to any one of items 23 through 25
   wherein each data processor further comprises at least one input interface for receiving data packets to be processed and an output interface for outputting processed data packets, and
   wherein at least the output interface of the first data processor is connected via the switching network or the connection network, respectively, to the input interface of a second data processor.
27. The data processing system according to item 22, including
   a storage unit in which at least two different coding keys and at least two different coding algorithms are stored;
   a data processor with a programmable logic circuit for processing received data packets; and
   a control unit that at least receives the data packets of the data stream, reads different coding algorithms in chronological succession from the storage unit and programs the logic circuit of the data processor accordingly, and reads different coding keys in chronological succession from the storage unit and outputs them together with the data to be processed to the data processor,
   wherein the control unit further receives data processed using the coding key and coding algorithm from the data processor, and
   wherein the control unit further outputs the data received by the data processor at least once to the data processor and controls it in such a way that the data processor processes a data packet to be processed received by the control unit at least twice in chronological succession using different coding algorithms and different coding keys.
28. The data processing system according to any one of items 22 through 27
   wherein the control unit, upon receiving a data packet to be encrypted, automatically determines a number,
type, and sequence of coding algorithms to be used in the subsequent encryption operations, determines different coding keys to be used in the subsequent encryption operations, and assigns one respective coding key to one respective coding algorithm in one respective encryption operation,
   wherein the control unit further controls the at least one data processor accordingly to obtain a plurally encrypted data packet, and
   wherein the control unit further automatically creates an unencrypted coding characteristic, said coding characteristic specifying at least the latest coding algorithm used and the assigned coding key, and
outputs the coding characteristic together with the plurally encrypted data packet.
29. The data processing system according to item 28, wherein the control unit further determines automatically at least one formatting instruction of the coding algorithm used in the respective encryption operation, the at least one formatting instruction defining a structure of the data packet that can be encrypted using the respective coding algorithm and adjusting the structure of the data packet to be encrypted using the at least one formatting instruction to the respective coding algorithm before outputting it to the respective data processor.
30. The data processing system according to item 28 or 29, wherein the control unit further automatically reads a main coding key from the storage unit, divides it into several different partial coding keys, and assigns one respective partial coding key to one respective coding algorithm in one respective encryption operation.
31. The data processing system according to item 28, 29, or 30
   wherein the control unit further automatically reads a coding format instruction of the coding algorithm to be used in the respective encryption operation from the storage unit, said at least one coding format instruction defining a structure of the coding key that can be used with the respective coding algorithm and taking the coding format instruction into consideration when determining the coding key to be used in the respective encryption operation.
32. The data processing system according to any one of items 28 through 31
   wherein the control unit further automatically adds random data to the data packet to be encrypted before outputting the data packet to be encrypted to the respective data processor and creates a random data characteristic for the data packet to be encrypted that comprises the random data, said random data characteristic specifying a section filled with random data of the data packet to be encrypted that comprises the random data.
33. The data processing system according to any one of items 28 through 32
   wherein the control unit further automatically calculates a control value for the data packet to be encrypted prior to outputting the data packet to be encrypted to the respective data processor.
34. The data processing system according to any one of items 22 through 27
   wherein the control unit, upon receiving plurally encrypted data packets to be decrypted, automatically detects at least one unencrypted coding characteristic assigned to the data packet, said coding characteristic specifying at least one coding algorithm and an assigned coding key and controls the at least one data processor in such a way that it decrypts the data packet to be decrypted using the at least one coding algorithm and assigned coding key specified in the at least one coding characteristic sequentially in at least two subsequent decryption operations.
35. The data processing system according to item 34, wherein the control unit further automatically detects unencrypted segmenting characteristic assigned to the data packet, said segmenting characteristic specifying data packets that are segments of a single whole data packet, and creates a whole data packet based on the decrypted data packets and the segmenting characteristic after decryption.
36. The data processing system according to item 34 or 35, wherein the control unit further automatically detects an unencrypted block characteristic in the data packet after decryption, said block characteristic identifying a user data packet contained in the data packet.
37. The data processing system according to item 34, 35, or 36
   wherein the control unit further automatically reads a main coding key from the storage unit and divides it into different partial coding keys based on the respective coding characteristic, and assigns one respective partial coding key depending on the respective coding characteristic to one respective coding algorithm in one respective decryption operation.
38. The data processing system according to any one of items 34 through 37
   wherein the control unit further automatically detects an unencrypted random data characteristic assigned to the data packet, said random data characteristic specifying a section of the data packet filled with random data, and removes said random data after decryption from the data packet using the detected random data characteristic.
39. The data processing system according to any one of items 34 through 38
   wherein the control unit further automatically detects a control value assigned to the data packet, calculates a check value using the data contained in the data packet, compares the control value with the check value and rejects the data packet if the control value does not match the check value.
40. The data processing system according to any one of items 34 through 39
   wherein the control unit further automatically adjusts the encrypted data packet or unencrypted data packet to a format of the unencrypted data packet received or the encrypted data packet received before outputting the encrypted data packet as a plurally encrypted data packet or the decrypted data packet as a plurally decrypted data packet.

1. A method of encrypting data packets of a data stream wherein a data packet to be encrypted is automatically encrypted sequentially in at least two subsequent encryption operations, comprising the following steps:
(S10) determining the number, type, and sequence of different coding algorithms to be used in the subsequent encryption operations;
(S12) determining the different coding keys to be used in the subsequent encryption operations;
(S13) assigning one respective coding key to one respective coding algorithm in one respective encryption operation; and
(S16, S17) sequentially encrypting a data packet to be encrypted in at least two subsequent encryption operations to obtain a plurally encrypted data packet.

2. The method of claim 1, further including the following steps:
(S18) creating an unencrypted coding characteristic for the plurally encrypted data packet, said coding characteristic at least specifying the latest coding algorithm used and the assigned coding key; and
(S19) outputting the coding characteristic together with the plurally encrypted data packet.

3. The method according to claim 2, further including:
adding the created unencrypted coding characteristic in each encryption operation to the respective encrypted data packet after encryption.

4. The method according to claim 1, each encryption operation including:
(S14) determining at least one formatting instruction of the coding algorithm used in the respective encryption operation wherein the at least one formatting instruction defines a structure of the data packets that can be encrypted using the respective coding algorithm; and
(S15) adjusting the structure of the data packet to be encrypted to the respective coding algorithm using the at least one formatting instruction.

5. The method according to claim 4 wherein adjusting the data packet to be encrypted includes:
segmenting the data packet to be encrypted into several partial data packets to be encrypted;
using the partial data packets instead of the data packet to be encrypted.
creating an unencrypted segmenting characteristic for the partial data packets to be encrypted wherein the segmenting characteristic identifies partial data packets obtained by segmenting a single data packet; and
outputting the segmenting characteristic together with the segmented partial data packets to be encrypted.

6. The method according to claim 4, wherein adjusting the data packet to be encrypted includes:
creating a data block, said data block containing the data packet to be encrypted and a block characteristic, wherein the block characteristic identifies the data packet to be encrypted in the data block; and
using the data block instead of the data packet to be encrypted.

7. A method of decrypting plurally encrypted data packets of a data stream comprising the following steps:
(S20) detecting at least one unencrypted coding characteristic assigned to the plurally encrypted data packet, said coding characteristic specifying at least one coding algorithm and one assigned coding key; and
(S21) sequentially decrypting the data packet to be decrypted in at least two subsequent decryption operations using the at least one coding algorithm and assigned coding key specified in the at least one coding characteristic.

8. The method according to claim 7 wherein at least one decryption operation includes the following steps:
(S22) detecting an unencrypted segmenting characteristic assigned to the data packet, said segmenting characteristic specifying data packets that are segments of a single whole data packet;
(S23) creating of the whole data packet based on the decrypted data packets and the segmenting characteristic after decryption; and
(S24) using the whole data packet instead of the data packet.

9. The method according to claim 7 wherein at least one decryption operation includes:
(S25, S26) detecting an unencrypted block characteristic in the data packet after decryption, said block characteristic in the data packet identifying a data packet to be used in the further procedure.

10. The method according to claim 1
wherein the different coding algorithms and/or coding keys are independent of each other.

11. A signal sequence that causes the execution of the method according to claim 1 if it is loaded into a data processor (61, 62; 63, 64, 65; 66), in particular a microprocessor, of a data processing system (11; 12; 13).

12. A data processing system (11; 12; 13),
said data processing system (11; 12; 13) at least receiving data packets of a data stream and processing the data packets received in accordance with a predefined instruction,
characterized in that
the data processing system (11; 12; 13) is programmed and set up to execute the method according to claim 1.

13. The data processing system (11) according to claim 12, including
a storage unit (41, 41′) in which at least two different coding keys (K1, K3) are stored;
at least two data processors (61, 62), each of which comprising a hard-wired logic circuit, said logic circuit implementing respective different coding algorithms (S1, S3) for processing a data packet received using a coding key (K1, K3);
a switching network (71) to optionally connect the data processors (61, 62) in series, the connection sequence of the two being changeable; and
a control unit (81) that controls the switching network (71) and the at least two data processors (61, 62), at least receives the data packets of the data stream and outputs them to a first of the at least two data processors (61, 62), reads different coding keys (K1, K3) from the storage unit (41, 41′) and outputs them to the data processors (61, 62).

14. The data processing system (12) according to claim 12, including
a storage unit (42) in which at least two different coding keys (K1-K9) and at least two different coding algorithms (S1-S9) are stored;
at least two data processors (63, 64, 65), each of which comprising a programmable logic circuit for processing data packets received;
a connection network (72) that connects the data processors (63, 64, 65) in series in a predefined order; and
a control unit (82) that controls the at least two data processors (63, 64, 65), reads different coding algorithms (S1-S9) from the storage unit (42) and programs the logic circuits of the data processors (63, 64, 65) accordingly, at least receives the data packets of the data stream and outputs them to a first of the at least two data processors (63, 64, 65), and reads different coding keys (K1-K9) from the storage unit (42) and outputs them to the data processors (63, 64, 65)
wherein the logic circuits of the respective data processor (63, 64, 65) programmed according to a respective coding algorithm (S1-S9) process the data packets received using the respective coding key (K1-K9) received.

15. The data processing system (13) according to claim 12, including
a storage unit (43, 43′) in which at least two different coding keys (K2, K3) and at least two different coding algorithms (S2, S3) are stored;
a data processor (66) with a programmable logic circuit for processing received data packets; and
a control unit (83) that at least receives the data packets of the data stream, reads different coding algorithms (S2, S3) in chronological succession from the storage unit (43, 43′) and programs the logic circuit of the data processor (66) accordingly, and reads different coding keys (K2, K3) in chronological succession from the storage unit (43, 43′) and outputs them together with the data to be processed to the data processor (66),
wherein the control unit (83) further receives data processed using the coding key (K2, K3) and coding algorithm from the data processor (66), and
wherein the control unit (83) further outputs the data received by the data processor (66) at least once to the data processor (66) and controls it in such a way that the data processor (66) processes a data packet to be processed received by the control unit at least twice in chronological succession using different coding algorithms (S2, S3) and different coding keys (K2, K3).

16. The data processing system (11; 12; 13) according to claim 12
wherein the control unit (81; 82; 83), upon receiving a data packet to be encrypted, automatically determines a number, type, and sequence of coding algorithms (S1-S9) to be used in the subsequent encryption operations, determines different coding keys (K1-K9) to be used in the subsequent encryption operations, and assigns one respective coding key (K1-K9) to one respective coding algorithm (S1-S9) in one respective encryption operation,
wherein the control unit (81; 82; 83) further controls the at least one data processor (61-66) accordingly to obtain a plurally encrypted data packet, and
wherein the control unit (81; 82; 83) further automatically creates an unencrypted coding characteristic, said coding characteristic specifying at least the latest coding algorithm (S1-S9) used and the assigned coding key (K1-K9), and outputs the coding characteristic together with the plurally encrypted data packet.

17. The data processing system (11; 12; 13) according to claim 16,
wherein the control unit (81; 82; 83) further determines automatically at least one formatting instruction of the coding algorithm (S1-S9) used in the respective encryption operation, the at least one formatting instruction defining a structure of the data packet that can be encrypted using the respective coding algorithm (S1-S9) and adjusting the structure of the data packet to be encrypted using the at least one formatting instruction to the respective coding algorithm (S1-S9) before outputting it to the respective data processor (61-66).

18. The data processing system (11; 12; 13) according to claim 16
wherein the control unit (81; 82; 83) further automatically reads a coding format instruction of the coding algorithm (S1-S9) to be used in the respective encryption operation from the storage unit (41, 41′; 42; 43, 43′), said at least one coding format instruction defining a structure of the coding key (K1-K9) that can be used with the respective coding algorithm (S1-S9) and taking the coding format instruction into consideration when determining the coding key (K1-K9) to be used in the respective encryption operation.

19. The data processing system (11; 12; 13) according to claim 12
wherein the control unit (81; 82; 83), upon receiving plurally encrypted data packets to be decrypted, automatically detects at least one unencrypted coding characteristic assigned to the data packet, said coding characteristic specifying at least one coding algorithm (S1-S9) and an assigned coding key (K1-K9) and controls the at least one data processor (61-66) in such a way that it decrypts the data packet to be decrypted using the at least one coding algorithm (S1-S9) and assigned coding key (K1-K9) specified in the at least one coding characteristic sequentially in at least two subsequent decryption operations.

20. The data processing system (11; 12; 13) according to claim 19
wherein the control unit (81; 82; 83) further automatically adjusts the encrypted data packet or unencrypted data packet to a format of the unencrypted data packet received or the encrypted data packet received before outputting the encrypted data packet as a plurally encrypted data packet or the decrypted data packet as a plurally decrypted data packet.
